(19) United States
(12) Patent Application Publication
(10) Pub. No.: US 2005/0091129 A1
(43) Pub. Date: Apr. 28, 2005

(54) System and method for managing shipment in a supply chain

(76) Inventor: Chih Yao Tien, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/920,758

(22) Filed: Aug. 17, 2004

(30) Foreign Application Priority Data
Oct. 24, 2003 (TW) 92129549

(51) Int. Cl. G06F 17/60

(52) U.S. Cl. 705/28

(57) ABSTRACT

A system for managing shipment in a supply chain includes a vendor-managed inventory hub (VMI hub) (10), at least one buyer (20) and at least one vendor (30). The VMI hub includes a server (11) which comprises: a purchase order (PO) management module (110) for receiving purchase orders from the buyer, and for maintaining the purchase orders; a data verification module (111) for verifying whether current inventory of a material satisfies requirements specified in the purchase orders, and for verifying whether information on an advance shipping notice accords with information on a corresponding delivery notice; a delivery management module (112) for transmitting delivery notices to the vendor, receiving advance shipping notices from the vendor, and for scheduling goods receipt; and a shipment management module (113) for managing shipment in the VMI hub. A method for managing shipment in a supply chain is also disclosed.

### BACKGROUND OF THE INVENTION

1. Field of the Invention

The present invention relates generally to shipment management systems and methods, and especially to a system and method for managing shipment in a supply chain via electronic communications networks.

2. Description of the Related Art

Vendor-managed inventory (VMI) is a business method which relates to vendor and customer interaction in an effort to minimize the customer's share of distribution costs and to eliminate inventory shortages associated with distributing a vendor's goods. Vendors that are able to reduce the customer's costs incurred in the purchase and distribution of the vendors' goods provide an added incentive for the customer to purchase more goods.

The art of automated vendor-managed inventory has been disclosed in records such as U.S. Pat. Publication No. 2003023503, entitled Vendor-managed Inventory Method and System and published on Jan. 30, 2003. This patent illustrates a vendor-managed inventory system based on a network environment, the VMI system comprising a vendor system, a buyer system and an external network interconnecting the vendor and buyer systems. The buyer system includes a buyer server, multiple workstations and manufacturing devices, a plurality of storage locations, and a sensor device. These entities of the buyer system are connected or linked through an internal network. Each storage location stores a small quantity of production material to be consumed by one of the manufacturing devices. The sensor device monitors quantities of materials at the storage locations via the internal network. When a quantity of any material falls below a specified threshold, the sensor device triggers an alert signal. The alert signal is then transferred to the buyer server, and material requirements information is generated and transmitted to the vendor system. Afterward, the required material is delivered to the buyer's premises by the vendor.

Although the system described above can reduce a level of stock for a buyer system, it cannot significantly lower inventory of a corresponding vendor. It is necessary that the vendor monitor a material consumption status of its customer at all times, and have material stock on hand in order to timely supply the buyer. Therefore, the vendor is burdened with more inventory costs and management duties in controlling inventory of the supply chain.

To solve these problems, another type of VMI has been developed. In this type of VMI, a relatively independent VMI hub is set up, in order to manage inventories for both a buyer and a corresponding vendor. When a shortage of material occurs, the buyer transmits purchase orders (POs) to the VMI hub. Then, the VMI hub timely supplies the buyer with the required material. If current inventory of the material in the VMI hub cannot satisfy the requirements specified in the POs, the VMI hub sends a delivery notice to the vendor, requiring the vendor to timely replenish its stock. The VMI hub is preferably located near the buyer. Nevertheless, the VMI hub can be established by a third party, or by either the buyer or the vendor. The VMI hub has various logistics functions, and provides efficient and professional logistics services. This can help both the buyer and the vendor reduce their inventory costs and management duties.

To improve the efficiency of shipment in the supply chain, an electronic response called an advance shipping notice (ASN) is used. An ASN is initiated by the vendor to notify the buyer (or the VMI hub) of a planned shipment, and provides the ability to greatly improve accuracy and speed in processing receipts. By knowing exactly what is coming, and when it will arrive, VMI hub personnel can be fully prepared before the goods arrive. By knowing details of the shipment ahead of the actual arrival, the incoming goods can be efficiently handled. ASNs are also useful for planning manpower and space requirements for both the VMI hub and the buyer.

U.S. Pat. No. 5,315,508, issued on May 24, 1994 and entitled Label Generating and Data Tracking System for Processing Purchase Orders, discloses a PO processing system that allows POs issued from a number of consignees (or buyers) each requiring different processing operations to be processed simply and accurately. The system prompts a user only for the particular information required by a selected consignee, in order to process a PO issued by the consignee. In processing a PO, the system verifies packing information against stored PO data. The system automatically generates shipping labels and ASNs in compliance with the differing requirements of the various consignees.

However, the system described in this patent does not address how to utilize an ASN to schedule goods receipt in advance. In addition, when an ASN provided by the vendor does not accord with information on a delivery notice previously transmitted to the vendor, the VMI hub cannot receive required materials in a set period specified in the POs received from the buyer. This can greatly retard the efficiency of shipment in the supply chain. Accordingly, what is needed is a system and method for managing shipment in a supply chain which can overcome the above-described problems.

### SUMMARY OF THE INVENTION

A main objective of the present invention is to provide a system and method for managing shipment in a supply chain which can transmit delivery data through communications networks in order to let goods receivers schedule goods receipt in advance.

Another objective of the present invention is to provide a system and method for managing shipment in a supply chain which can notify a vendor of the need to renew an advance shipping notice when information on the advance shipping notice does not accord with information on a delivery notice previously transmitted to the vendor from a VMI hub.

To achieve the above objectives, the present invention provides a system for managing shipment in a supply chain which integrates a vendor-managed inventory hub (VMI hub), at least one buyer and at least one vendor. The VMI hub comprises a server, a database linking to the server, and at least one hub warehouse. The server comprises: a purchase order (PO) management module for receiving POs from the buyer, and for maintaining the POs; a data verification module for verifying whether current inventory of a material in the hub warehouse satisfies requirements specified in the POs, and for verifying whether information of an advance shipping notice (ASN) received from the vendor accords with information of a corresponding delivery notice previously transmitted to the vendor; a delivery management module for generating delivery notices and transmitting the delivery notices to the vendor, for receiving ASNs from the vendor, and for scheduling goods receipt; a shipment management module for managing shipment operations in the hub warehouse; and a data maintenance module for managing and maintaining data stored in the database.

Further, the present invention provides a method for managing shipment in a supply chain. The method comprises the steps of: receiving purchase orders (POs) from one or more buyers; determining whether current inventory of a material satisfies requirements specified in the POs; transmitting delivery notices to one or more corresponding vendors if the current inventory of any material cannot satisfy the requirements specified in the POs; receiving advance shipping notices (ASNs) from the one or more vendors; comparing information on the ASNs and the delivery notices; scheduling goods receipt according to the ASNs if the information on the ASNs accords with the delivery notices; receiving goods delivered by the one or more vendors, and generating goods receipt data; scheduling shipment according to the POs and the goods receipt data; and shipping goods to the one or more buyers.

Other objects, advantages and novel features of the present invention will be drawn from the following detailed description of a preferred embodiment and preferred method of the present invention with the attached drawings, in which:

### BRIEF DESCRIPTION OF THE DRAWINGS

FIG. 1 is a schematic diagram of hardware configuration of a system for managing shipment in a supply chain in accordance with the present invention;

FIG. 2 is a schematic diagram of main function modules of a server of the system of FIG. 1;

FIG. 3 is a schematic diagram showing main fields of an exemplary ASN; and

FIG. 4 is a flowchart of a method for managing shipment in a supply chain in accordance with the present invention.

### DETAILED DESCRIPTION OF THE PREFERRED EMBODIMENT

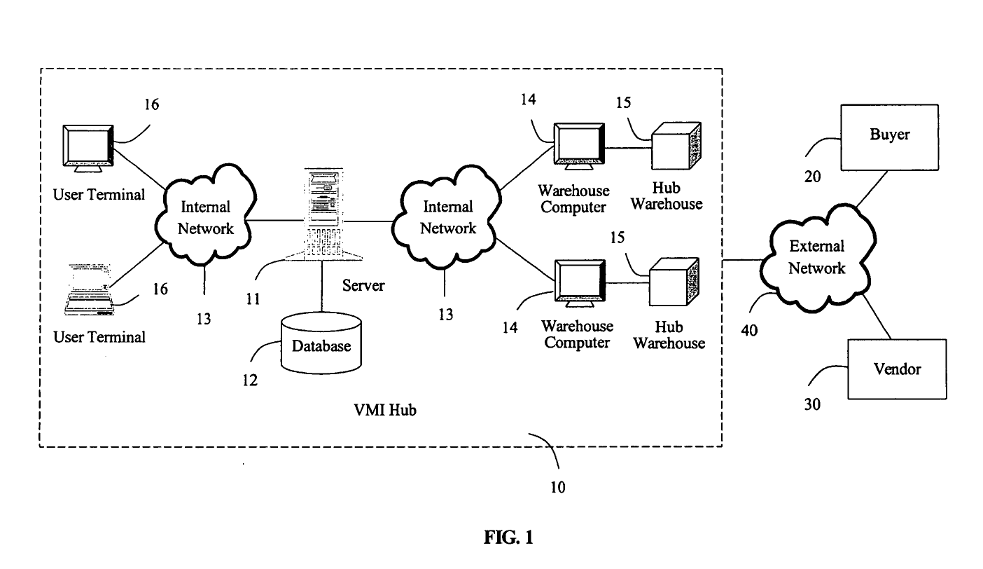

FIG. 1 is a schematic diagram of hardware configuration of a system for managing shipment in a supply chain in accordance with the present invention. The supply chain comprises a vendor-managed inventory hub (VMI hub) 10, a buyer 20 and a vendor 30. The three entities are interconnected through an external network 40. The external network 40 may be any appropriate high-speed communications network known in the art, such as a private network or the Internet, and may include wireless technology and devices. Although only one buyer 20 and one vendor 30 are shown, the supply chain may alternatively comprise, for example, a plurality of buyers 20 and a plurality of vendors 30.

The VMI hub 10 may be considered as an inventory management site for the supply chain, and may partially function as a logistics center. The VMI hub 10 stores and manages goods delivered by the vendor 30, receives purchase orders (POs) from the buyer 20, and supplies the buyer 20 with required materials. Typically, the VMI hub 10 is located near the buyer 20, in order to timely replenish stocks for the buyer 20.

The VMI hub 10 comprises a server 11, a database 12, a plurality of warehouse computers 14, a plurality of hub warehouses 15, a plurality of user terminals 16, and an internal network 13 interconnecting all these entities. The server 11 may execute various software applications, for enabling the entities of the VMI hub 10 to communicate with each other as well as for performing various enterprise level tasks. Such tasks include receiving POs from the buyer 20, transmitting delivery notices to the vendor 30, and receiving advance shipping notices (ASNs) from the vendor 30. The software applications that can be executed by the server 11 include enterprise resource planning software, email software, database management software, and other tools commonly used in a business environment.

The hub database 12 is provided for storing data or records used or generated by the VMI hub 10. Such data comprise goods inventory data, POs, delivery notices, ASNs, goods receipt data and shipment records. Each warehouse computer 14 is located at a corresponding hub warehouse 15, for managing and maintaining information on goods receipt and shipment. The warehouse computer 14 connects with one or more scanning devices (not shown). When goods delivered by the vendor 30 arrive at the hub warehouse 15, the scanning devices scan barcodes attached to the goods containers, in order to obtain detailed goods receipt data. The goods receipt data include names, item numbers, delivery dates, quantities, prices for the delivered goods, and other related information on the delivery. The scanning devices can also scan barcodes attached to the containers that are shipped to the buyer 20 from the VMI hub 10, in order to generate shipment records according to information on the barcodes. Each shipment record comprises a shipment date, names, item numbers, quantities and prices for the shipped goods, etc. The hub warehouses 15 store goods delivered by the vendor 30, in order to timely supply the buyer 20 with required materials. The user terminals 16 may be general-purpose computer devices such as personal computers, laptops, portable handheld devices (e.g., personal digital assistants), or other suitable computing devices known in the art. Each user terminal 16 provides a user interface for users of the VMI hub 10 to maintain inventory data, and to manage shipment operations. The internal network 13 may be any suitable communications architecture needed for the VMI hub 10, such as a local area network, a wide area network, etc.

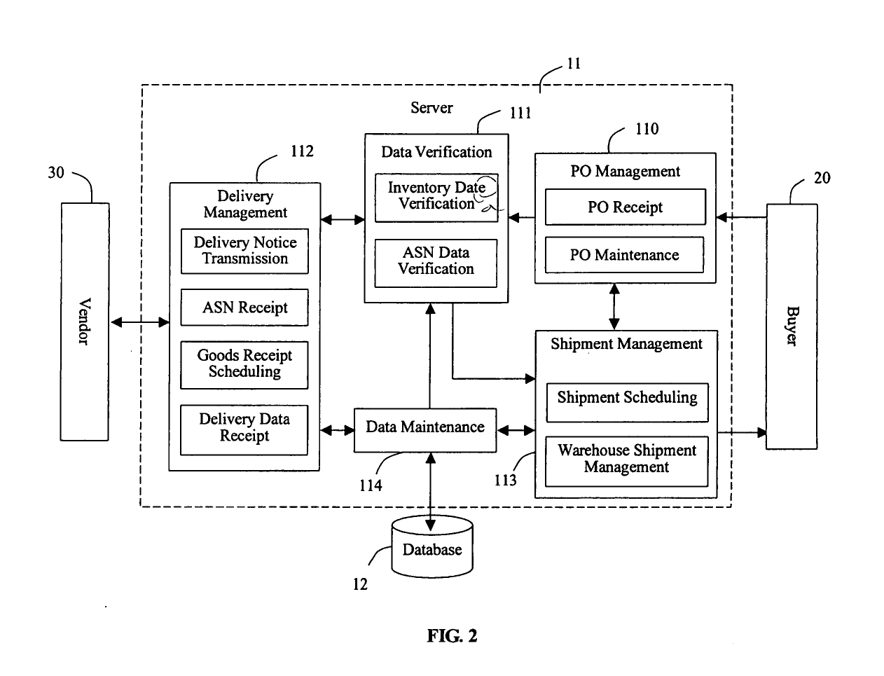

FIG. 2 is a block diagram of main function modules of the server 11, showing data interchange among the function modules and also between the function modules and the buyer 20, the vendor 30 and the database 12. The server 11 comprises a PO management module 110, a data verification module 111, a delivery management module 112, a shipment management module 113, and a data maintenance module 114.

The PO management module 110 includes a PO receipt sub-module for receiving POs from the buyer 20, and a PO maintenance sub-module for maintaining those POs. The data verification module 111 is provided for verifying whether current inventory of a material in the hub warehouse 15 satisfies the requirements specified in the POs, and also for verifying whether information on an ASN received from the vendor 30 accords with information on a corresponding delivery notice previously transmitted to the vendor 30. Accordingly, the data verification module 111 comprises an inventory data verification sub-module, and an ASN data verification sub-module. The inventory data verification sub-module obtains POs from the PO management module 110, and reads current inventory data on the materials specified in the POs from the database 12 via the data maintenance module 114. By comparing information on the POs with the current inventory data, the inventory data verification sub-module determines whether current inventories for all the materials required by the buyer 20 are sufficient. The ASN data verification sub-module retrieves ASNs from the delivery management module 112, obtains corresponding delivery notices previously transmitted to the vendor 30 from the database 12, and determines whether information on the ASNs and information on the delivery notices is consistent.

The delivery management module 112 comprises a delivery notice transmission sub-module, an ASN receipt sub-module, a goods receipt scheduling sub-module, and a delivery data receipt sub-module. When current inventory of any material in the hub warehouse 15 is insufficient according to the requirements specified in the POs, the delivery notice transmission sub-module generates a delivery notice. The delivery notice is stored in the database 12, and transmitted to the vendor 30. The ASN receipt sub-module then receives an ASN from the vendor 30, and stores the ASN in the database 12. The goods receipt scheduling sub-module schedules goods receipt according to the ASN. This includes assigning manpower for goods receipt, and designating proper hub warehouses for storing the goods. When the delivered goods arrive, hub warehouse operators scan barcodes attached to the goods containers by using the scanning devices. The barcodes are obtained by the delivery data receipt sub-module to generate goods receipt data.

The shipment management module 113 manages shipment operations in the hub warehouse 15, and comprises a shipment scheduling sub-module and a warehouse shipment management sub-module. The shipment scheduling sub-module can automatically schedule shipment for the VMI hub 10 based on some business rules known in the art, such as the principle of first in, first out. When materials are ready to be shipped to the buyer 20 from the hub warehouse 15, the warehouse shipment management sub-module receives barcodes that are attached to the goods containers and scanned by the scanning devices, and generates a shipment record. The data maintenance module 114 directly connects with the database 12, for managing and maintaining all the data stored therein.

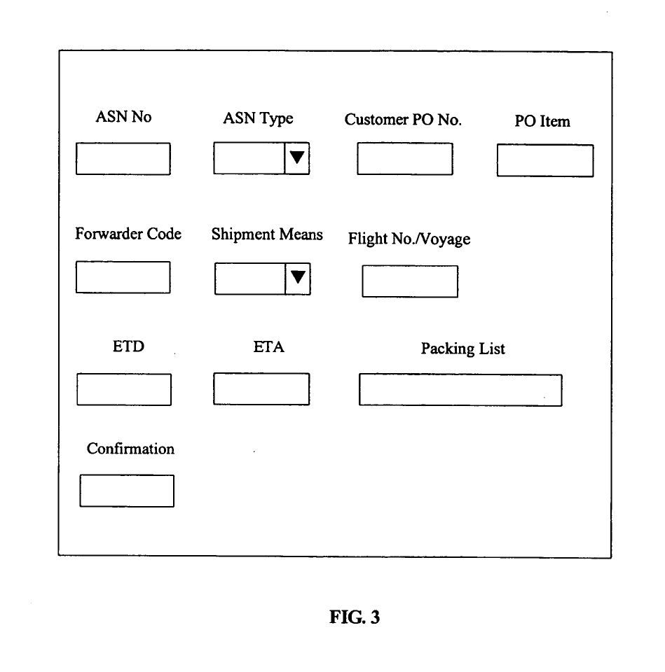

FIG. 3 is a schematic diagram showing main fields of an exemplary ASN. The ASN comprises: ASN Number, ASN Type, Customer PO No., PO Item, Forwarder Code, Shipment Means, Flight No./Voyage, Estimated Time of Departure (ETD), Estimated Time of Arrival (ETA), Packing List, and Confirmation. The fields of ASN Type and Shipment Means provide dropdown menus for users to make choices when generating an ASN. The ASN Type includes two options: Delivery and Transference. Goods can be shipped by air, by sea, by land or by express. The Packing List field lists detailed information on delivered goods. Such information comprises: ASN No., Vendor Name, Vendor Code, Vendor Part No., Customer No., Customer Code, Goods Description, Shipping Quantity, Price, Invoice No., etc.

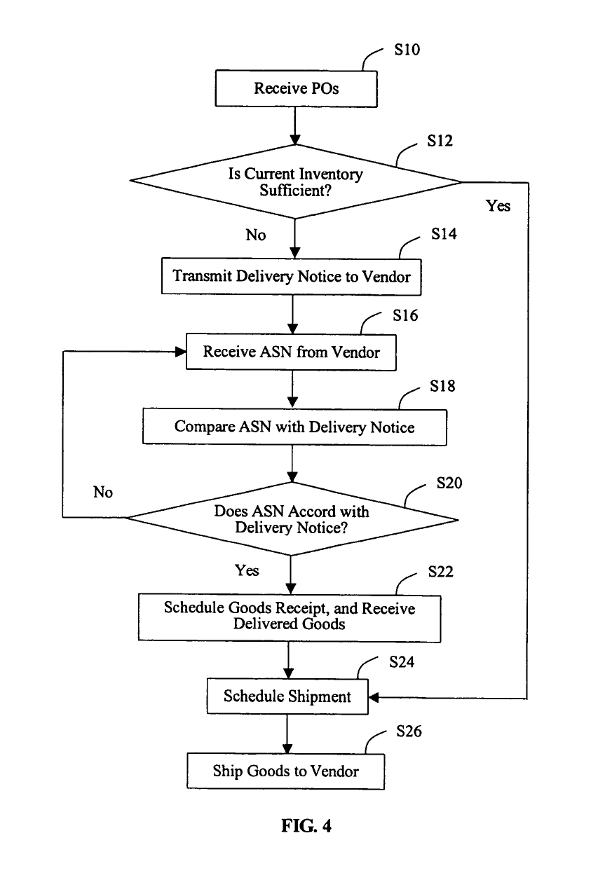

FIG. 4 is a flowchart of a method for managing shipment in a supply chain by implementing the above-described system. In step S10, the PO management module 110 receives POs from the buyer 20. In step S12, the data verification module 111 retrieves current inventory data on the materials specified in the POs from the database 12, and determines whether the materials stored in the hub warehouse 15 are sufficient to satisfy the requirements specified in the POs.

If the materials stored in the hub warehouse 15 are sufficient according to the requirements specified in the POs, the procedure goes directly to step S24 described below. If there is any material whose current inventory is insufficient, in step S14, the delivery management module 112 automatically generates a delivery notice. The delivery notice is then transmitted to the vendor 30 that provides the material, informing the vendor 30 of material that is required to be delivered. In step S16, the vendor 30 transmits an ASN to the delivery management module 112 according to the received delivery notice, notifying the VMI hub 10 of information on delivered goods. In step S18, the data verification module 111 reads the ASN from the delivery management module 112, and compares the ASN with the delivery notice previously transmitted to the vendor 30. In step S20, the data verification module 111 verifies whether information on the ASN accords with information on the delivery notice, in order to determine whether the material that is to be delivered by the vendor satisfies the requirements specified in the delivery notice.

If the ASN does not accord with the delivery notice, the procedure returns to step S16 described above. That is, the vendor 30 transmits a renewed ASN to the delivery management module 112. If the ASN accords with the delivery notice, in step S22, the delivery management module 112 schedules goods receipt according to the ASN, and notifies the vendor 30 to deliver the material within a period prescribed in the POs. When the material arrives, it is moved to a proper hub warehouse 15 without delay. Operators of the hub warehouse 15 scan barcodes attached to the goods containers by using the scanning devices connected with the corresponding warehouse computer 14. The delivery management module 112 receives the barcodes from the warehouse computer 14, and generates detailed goods receipt data. The goods receipt data are stored in the database 12. In step S24, the shipment management module 113 schedules shipment according to the POs and the goods receipt data. In step S26, the hub warehouse 15 delivers the goods to the buyer 20. The warehouse computer 14 receives barcodes attached to the goods containers that are scanned by the scanning devices, and transmits the barcodes to the server 11. The shipment management module 113 automatically generates a shipment record according to the received barcodes, and stores the shipment record in the database 12.

Although the present invention has been specifically described on the basis of a preferred embodiment and preferred method, the invention is not to be construed as being limited thereto. Various changes or modifications may be made to the embodiment and method without departing from the scope and spirit of the invention.

1. A system for managing shipment in a supply chain, the supply chain integrating a vendor-managed inventory hub (VMI hub), at least one buyer and at least one vendor, the VMI hub comprising a server, a database linking to the server, and at least one hub warehouse, wherein the server comprises:
a purchase order management module for receiving one or more purchase orders from said buyer, and for maintaining the purchase orders;
a data verification module for verifying whether current inventory of a material in said hub warehouse satisfies the requirements specified in the purchase orders, and for verifying whether information on an advance shipping notice received from said vendor accords with information on a corresponding delivery notice previously transmitted to said vendor;
a delivery management module for transmitting delivery notices to said vendor, for receiving advance shipping notices from said vendor, and for scheduling goods receipt; and
a shipment management module for managing shipment in the VMI hub.

2. The system as claimed in claim 1, wherein the server further comprises a data maintenance module for managing and maintaining data stored in the database.

3. The system as claimed in claim 1, wherein the data verification module comprises an inventory data verification sub-module for verifying whether current inventory of a material in said hub warehouse satisfies the requirements specified in the purchase orders received from said buyer.

4. The system as claimed in claim 3, wherein the data verification module further comprises an advance shipping notice data verification sub-module for verifying whether information on an advance shipping notice received from said vendor accords with information on a corresponding delivery notice previously transmitted to said vendor.

5. The system as claimed in claim 1, wherein the delivery management module comprises a delivery notice transmission sub-module for generating delivery notices and transmitting the delivery notices to said vendor when current inventory of any material in said hub warehouse cannot satisfy the requirements specified in the purchase orders.

6. The system as claimed in claim 5, wherein the delivery management module further comprises an advance shipping notice receipt sub-module for receiving advance shipping notices from said vendor.

7. The system as claimed in claim 5, wherein the delivery management module further comprises a goods receipt scheduling sub-module for scheduling goods receipt according to the received advance shipping notices.

8. The system as claimed in claim 5, wherein the delivery management module further comprises a delivery data receipt sub-module for receiving barcodes attached to goods containers delivered by said vendor and generating goods receipt data according to the received barcodes.

9. The system as claimed in claim 1, wherein the shipment management module comprises a shipment scheduling sub-module for scheduling shipment for the VMI hub.

10. The system as claimed in claim 9, wherein the shipment management module further comprises a warehouse shipment management sub-module for receiving barcodes attached to goods containers shipped to said buyer and generating shipment records according to the barcodes.

11. A method for managing shipment in a supply chain, the method comprising the steps of:
receiving purchase orders from one or more buyers;
determining whether current inventory of a material satisfies requirements specified in the purchase orders;
transmitting delivery notices to one or more corresponding vendors if the current inventory of any material cannot satisfy the requirements specified in the purchase orders;
receiving advance shipping notices from the one or more vendors;
comparing information on the advance shipping notices with the delivery notices;
scheduling goods receipt according to the advance shipping notices if the information on the advance shipping notices accords with the delivery notices;
receiving goods delivered by the one or more vendors, and generating goods receipt data;
scheduling shipment according to the purchase orders and the goods receipt data; and
shipping goods to the one or more buyers.

12. The method as claimed in claim 11, further comprising the step of:
directly scheduling shipment according to the purchase orders and the goods receipt data if the current inventory of all materials satisfies the requirements specified in the purchase orders.

13. The method as claimed in claim 11, further comprising the step of:
receiving a renewed advance shipping notice from a corresponding vendor if the information on any advance shipping notice does not accord with the corresponding delivery notice.

14. A method for managing shipment in a supply chain, the method comprising the steps of:
receiving a purchase order from one buyer;
determining whether current inventory of a material satisfies requirements specified in the purchase order;
transmitting a delivery notice to a vendor if the current inventory of the material cannot satisfy the requirements specified in the purchase order;
receiving an advance shipping notice from the vendor;
scheduling goods receipt and shipment according to the advance shipping notice if information on the advance shipping notice accords with the delivery notice.
